(19) United States
(12) Patent Application Publication
(10) Pub. No.: US 2004/0100689 A1
(43) Pub. Date: May 27, 2004

(54) Semiconductor optical device arrays

(75) Inventors: Stephen James Fasham, Bedfordshire (GB); Andrew Michael Tomlinson, Oxford (GB); Craig Tombling, Oxford (GB); Anthony Edward Kelly, West Kilbride (GB)

Correspondence Address: SIERRA PATENT GROUP, LTD., P O BOX 6149, STATELINE, NV, 89449, US

(73) Assignee: Kamelian Limited, a Corporation of the United Kingdom.

(21) Appl. No.: 10/633,327

(22) Filed: Aug. 1, 2003

(30) Foreign Application Priority Data
Aug. 2, 2002 (GB) 0218038.8

(51) Int. Cl. H01S 3/00

(52) U.S. Cl. 359/344

(57) ABSTRACT

An array of SOAs integrated in a semiconductor chip 1 is optically coupled to an array of waveguides 12 arranged on a substrate 10 of a passive device by mounting the semiconductor chip 1 on the substrate 10 to form a hybrid optical assembly. The semiconductor chip 1 is manufactured with a redundant array of SOAs. In a first aspect, the array of SOAs A1, A2, etc are arranged with a pitch equal to the predetermined pitch at which the array of waveguides 12 are arranged on the substrate 11 divided by an integer greater than 1. In a second aspect, the SOA A, B, C are arranged at the same predetermined pitch at which the array of waveguides 12 are arranged, but the number of SOAs A, B, C in the array on the semiconductor chip 1 is greater than the number of waveguides 12 arranged on the substrate 10. The substrate 10 is provided with grooves 14 which define alignment surfaces 17 and 18 corresponding to alignment surfaces 6 and 5 formed on the semiconductor chip 1 for relative alignment of the SOAs with the waveguides 12.

### BACKGROUND OF THE INVENTION

The present invention relates to the manufacture of an array of semiconductor optical devices integrated in a single semiconductor chip. In use, such arrays are optically coupled to an array of waveguides, typically by mounting the array of semiconductor optical devices on a substrate on which the waveguides are arranged to form an optical assembly.

The present invention also relates to the arrangement of such arrays of semiconductor optical devices and such substrates. The use of an array of semiconductor optical devices integrated in a single semiconductor chip is well known in the optoelectronics field for different types of semiconductor optical device, such as lasers and detectors. The devices of such an array are optically coupled to waveguides arranged in an array at the same pitch as the optical devices, for supply of input light to devices such as detectors, or for receiving output signals from devices such as lasers. More recently, there has been proposed an array of semiconductor optical amplifiers optically coupled to an array of waveguides, either in the form of optical fibres mounted in a fibre-block assembly or in the form of waveguides integrated into a passive structure, to form a hybrid assembly.

Particularly in telecommunications applications, it is desirable to use arrays with an ever increasing number of semiconductor optical devices. However, as the number of semiconductor optical devices increases, the manufacturing yield for the array decreases. A failure of any single device within the array makes the array unusable as an optical component. Therefore, there is a trade-off between increasing the number of devices in the array and maintaining an acceptable manufacturing yield. It would be desirable to increase the yield for the entire array as an optical component, so that it is possible to manufacture large arrays whilst maintaining an acceptably high yield.

### BRIEF SUMMARY OF THE INVENTION

According to a first aspect of the present invention, there is provided a method of manufacturing an array of semiconductor optical devices in a single semiconductor chip to be optically coupled to an array of waveguides arranged at a predetermined pitch, the method comprising manufacturing of the array of semiconductor optical devices as a plural number of interleaved sub-arrays of semiconductor optical devices arranged, in each sub-array, at a pitch equal to the predetermined pitch.

Alternatively, according to the first aspect of the present invention, there is provided a method of manufacturing an array of semiconductor optical devices in a single semiconductor chip to be optically coupled to an array of waveguides arranged at a predetermined pitch, the method comprising manufacturing the array of semiconductor optical devices with a pitch equal to the predetermined pitch divided by an integer greater than one.

Further according to the first aspect of the present invention, there is provided an optical assembly comprising an array of semiconductor optical devices formed in a single semiconductor chip and optically coupled to an array of waveguides arranged at a predetermined pitch, wherein the array of semiconductor optical devices comprises a plural number of interleaved sub-arrays of semiconductor optical devices arranged, in each sub-array, at a pitch equal to the predetermined pitch.

The first aspect of the present invention provides a significant advantage of increasing the manufacturing yield for the array of semiconductor optical devices as an optical component. In particular, by arranging the semiconductor optical devices to comprise a plural number of interleaved sub-arrays of semiconductor optical devices arranged, in each sub-array, at a pitch equal to the predetermined pitch, there is redundancy in the number of semiconductor optical devices provided. Redundant sub-arrays are provided by interleaving the sub-arrays. Thus the redundancy is achieved by increasing the pitch of the individual devices. Any of the sub-arrays of semiconductor optical devices may be optically coupled to the array of waveguides. This increases the manufacturing yield for the array as a whole, because the array is functional if any one of the sub-arrays is functional. There is a lower probability of all the sub-arrays failing than the probability of a single sub-array failing.

The increase in yield due to redundancy is advantageous in itself, but also makes it possible to provide a large array of semiconductor optical devices (counting the number of devices coupled to a waveguide rather than the total number of devices), whilst maintaining the manufacturing yield for an array as a whole at an acceptable level. Such an increase in the size of the array is a significant advantage. For example, it reduces the number of piece parts needed to produce a system having a given functionality. This reduces the amount of optical coupling needed between different components which is difficult and time consuming, particularly in a complex assembly, because of the high degree of alignment necessary.

In general, the plural number, which is equal to the redundancy factor, may take any value. Preferably, the plural number is as high as possible, with the maximum limit being controlled by the physical limits on the minimum size and separation of the devices in the array. However, significant improvements in yield may be obtained even if the plural number is only two.

Preferably, the pitch of the devices in the array is constant, equal to the predetermined pitch of the waveguides divided by the plural number. This means the minimum spacing between any two devices is maximised. However, the advantages provided by the redundancy are still achieved if the sub-arrays are offset from the position where all the devices are equidistant.

The semiconductor optical device may be of any type. The invention is particularly applicable to semiconductor chips formed substantially of materials in groups HI and V of the periodic table, for example in which the base materials of the semiconductor chip are InP. The present invention is particularly suitable for a semiconductor optical amplifier (SOA) because, there is a particular demand for large arrays of SOAs in telecommunications applications. However, the devices may equally be of any other type, for example a laser or a detector.

The waveguides of the array of waveguides may be of any type. The invention is particularly suitable for an array of waveguides integrated in a passive structure. Such a passive structure optically coupled to the array of semiconductor optical devices forms a hybrid optical assembly which may be provided with a wide range of functionality. However, the waveguides may equally be of any other type, for an example optical fibres. Optical fibres may be mounted in an array within a fibre block assembly which is conventional in itself for coupling to an array of semiconductor optical devices.

Preferably, the array of waveguides are arranged on a substrate and the array of semiconductor optical devices is mounted on the substrate.

Use of such a substrate facilitates the optical coupling of the semiconductor optical devices and the waveguides.

Advantageously, the array of waveguides are integrated with the substrate.

This facilitates the optical coupling, because the waveguides are integrated in the same structure as the substrate. However, the present invention is equally applicable to a separate substrate on which the array of waveguides are mounted.

Preferably, the substrate has alignment features for aligning a semiconductor optical device with respect to the substrate by contact with corresponding features of the semiconductor optical device, the alignment features being repeated at a pitch equal to the pitch of the array of semiconductor optical devices. The advantage of repeating the alignment features at the pitch equal to the pitch of the array of semiconductor optical devices is to increase the effectiveness of the alignment because there are alignment feature for each semiconductor optical device. It also improves thermal transfer if a contact is provided for each semiconductor optical device, including those not coupled to a waveguide.

When the array of semiconductor optical devices is used with an array of waveguides having a predetermined number of waveguides, the number of semiconductor optical devices may be equal to the predetermined number of waveguides in the array multiplied by the integer, in order to allow any one of the sub-arrays of interleaved devices to be optically coupled to the array of waveguides. However, advantageously, the number of semiconductor optical devices is greater than the number of waveguides multiplied by said plural number.

This increases the number of semiconductor optical devices, beyond that necessary to take advantage of the redundancy provided by reducing the pitch of the semiconductor optical devices. The further degree of redundancy makes the array of semiconductor optical devices longer than is necessary. The further redundancy yet further increases the manufacturing yield for the array as a whole. In particular, there are even more sub-arrays which may be coupled to the array of waveguides.

In fact, the increased redundancy achieved by increasing the length of the array, may be equally applied to arrays of semiconductor optical devices which are not in accordance of the first aspect of the present invention, but in which the devices are arranged at the predetermined pitch of the waveguides.

Therefore, in accordance with a second aspect of the present invention, there is provided a method of manufacturing an array of semiconductor optical devices integrated in a single semiconductor chip to be optically coupled to an array of n waveguides arranged at a predetermined pitch, where n is an integer greater than one, the method comprising: manufacturing the semiconductor chip to have, integrated therein, the array of semiconductor optical devices arranged at a pitch equal to the predetermined pitch, with the number of semiconductor optical devices in the array being greater than n; and testing the semiconductor optical devices of the array to identify a group of n adjacent semiconductor optical devices which all function.

Preferably, the method further comprises optically coupling the identified group of n adjacent semiconductor optical devices to the array of n waveguides.

Further in accordance with the second aspect of the present invention, there is provided an optical assembly comprising an array of semiconductor optical devices integrated in a single semiconductor chip and optically coupled to an array of waveguides arranged at a predetermined pitch, wherein the array of semiconductor optical devices are arranged at a pitch equal to the predetermined pitch of the array of waveguides and the number of semiconductor optical devices is greater than the number of waveguides in the array of waveguides.

The second aspect of the present invention allows the manufacturing yield for the array of semiconductor optical devices as a whole to be increased. This is because the number of semiconductor optical devices being greater than the number of waveguides introduces redundancy into the array of semiconductor optical devices. Therefore, there are plural groups of adjacent semiconductor optical devices which may be optically coupled to the array of waveguides. This increases the probability of there being a group of semiconductor optical devices which are all functional, as compared to the probability of all the devices being functional in an array having the same number of devices as the array of waveguides. Therefore, the manufacturing yield for the array of semiconductor optical devices as a whole is increased.

The increase in yield due to the redundancy is advantageous in itself but also makes it possible to provide a large array of semiconductor optical devices whilst maintaining the manufacturing yield for the array as a whole at an acceptable level. Such increase in the size of the array is a significant advantage. For example, it reduces the number of piece parts needed to produce a system having a given functionality, which in turn reduces the amount of optical coupling needed between different components.

The other features of the first aspect of the present invention are equally applicable to the second aspect of the present invention.

### BRIEF DESCRIPTION OF THE DRAWINGS

In the drawings:

FIG. 1 is a view of a semiconductor chip having an array of SOAs integrated therein, viewed from the end of the optical axes of the SOAs;

FIG. 2 is a view of the semiconductor chip of FIG. 1 from below in FIG. 1;

FIG. 3 is a view from above of a passive device for mounting the semiconductor chip of FIG. 1 thereon;

FIG. 4 is a cross-sectional of view of the passive device of FIG. 3 taken along the line IV-IV in FIG. 3;

FIG. 5 is a perspective view of the semiconductor chip of FIG. 1 and the passive device of FIG. 3 being brought together;

FIG. 6 is a perspective view of an optical assembly formed by the passive device of FIG. 3 with the semiconductor chip of FIG. 1 mounted thereon;

FIG. 7 is a view of a semiconductor chip having an array of SOAs integrated therein, viewed from the end of the optical axes of the SOAs;

FIG. 8 is a view of the semiconductor chip of FIG. 7 from below in FIG. 7;

FIG. 9 is a view from above of a passive device for mounting the semiconductor chip of FIG. 7 thereon;

FIG. 10 is a cross-sectional view of the passive device of FIG. 9 taken along the line X-X in FIG. 9; and

FIG. 11 is a perspective view of the passive device of FIG. 9 having the semiconductor chip of FIG. 7 mounted thereon.

### DETAILED DESCRIPTION OF THE INVENTION

Embodiments of the present invention will now be described merely by way of non-limitative example with reference to the accompanying drawings.

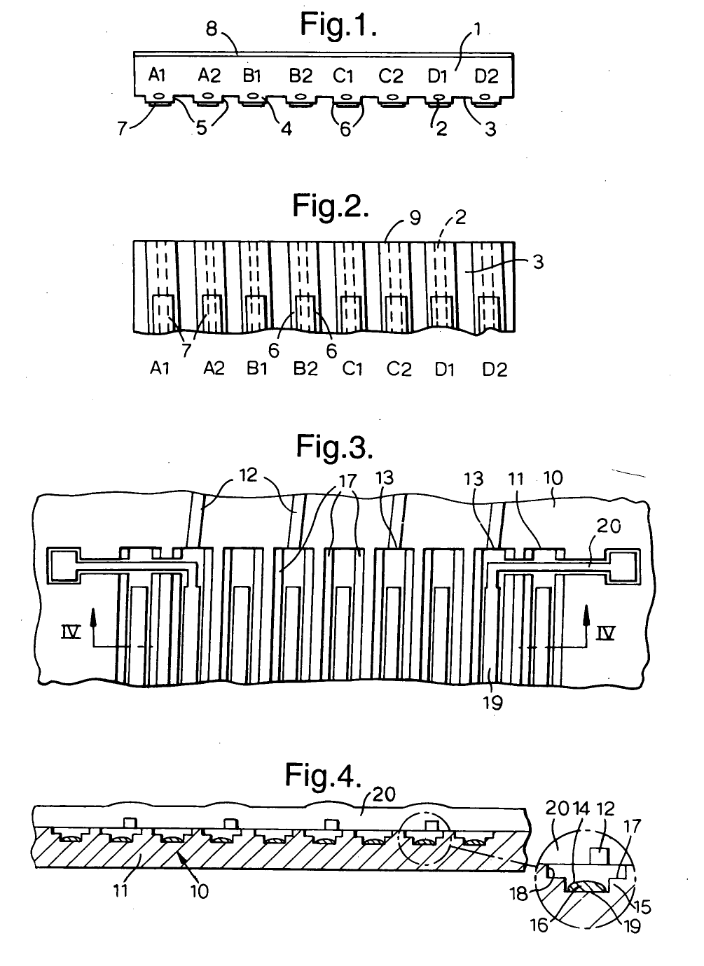

An optical assembly in accordance with the first aspect of the present invention will be described with reference to FIGS. 1 to 6. The optical assembly comprises a semiconductor chip 1 mounted on a substrate 10 of a passive device 11. For clarity, FIGS. 1 to 6 illustrate merely one end of the semiconductor chip 1 to show the coupling at a single end facet 9 of the semiconductor chip 1. At the opposite end of the semiconductor chip 1, the structure of the passive device 11 may be duplicated to couple the semiconductor chip to an array of waveguides 12 at each end facet 9.

FIGS. 1 and 2 illustrate, in end view and base view, respectively, the semiconductor chip 1 in which are formed an array of semiconductor optical amplifiers (SOAs) labelled A1, A2, B1, etc. Each SOA has a waveguide 2 along which light propagates. The waveguides 2 are formed adjacent to a surface 1a of the semiconductor chip 1, which is the lowermost surface in FIG. 1. An elongate amplification region of active material extends along each waveguide 2 to amplify light in a desired signal band representing a signal within a telecommunications network.

In principle, the amplification region of active material could extend along the entire waveguide 2. However, preferably the SOAs waveguides 2 are provided with a mode expander region inside the end facets 9 of the semiconductor chip 1. Such a mode expander region acts to change the size of the mode between a small size supported by the waveguide 2 inside the semiconductor chip 1 appropriate for the amplification region and a large size which is closer to the mode size supported by the waveguides of the array 12 (described in more detail below). To achieve this, the waveguide 2 may comprise a layer of active material forming an active waveguide tapered at the end to form a mode expander region. The waveguide 2 may further comprise a layer of passive material forming a passive waveguide and disposed optically coupled to the layer of active material the passive waveguide being sized to support a mode of larger size than the active waveguide and extending beyond the ends of the active waveguide.

The semiconductor chip 1 including the array of SOAs A1, A2, etc formed therein is of known construction and may be manufactured using conventional deposition and lithographic techniques. It is preferably (but not exclusively) formed substantially of materials in the groups III and V of the periodic table. Preferably, the base materials of the semiconductor chip 1 are In and P. The SOAs A1, A2, etc are optimised for use within the telecommunications network, and preferably have a gain centred around a particular telecommunications wavelength band, for example 1550 nm. The end facets 9 of the semiconductor chip 1 are formed with anti-reflection coatings or otherwise to have reflection coefficients of the order of 10⁻³ or 10⁻⁴.

Between each of the SOAs A1, A2, etc, the semiconductor chip 1 has grooves 3 formed in the surface la adjacent the waveguides 2 of the SOAs A1, A2, etc. The grooves 3 parallel to the optical axes of the SOAs A1, A2, etc. Between the grooves 3 are protrusions 4 in which the waveguides 2 of the SOAs A1, A2, etc are positioned. The grooves 3 are formed during manufacture by etching to have a precisely controlled width. The vertical surfaces 5 on one side of the grooves 3 form horizontal-alignment surfaces 5 which are used for alignment, as will be described in more detail below.

The waveguides 2 and protrusions 4 extend at a slight angle to the normal of the end facets 9 to reduce the amount of light reflected by the end facet 9 back along the waveguide 2.

As is conventional, in this application the direction in which the array of SOAs A1, A2 etc repeat, i.e. parallel to the end facets 9, will be referred to as the horizontal direction. Also, the direction perpendicular to the horizontal direction, and also perpendicular to the direction of the optical axes of the SOAs A1, A2, etc and the waveguides 12, will be referred to as the vertical direction. The terms “horizontal” and “vertical” are used merely to specify relative directions and do not imply any particular orientation of the semiconductor chip 1 and the passive device 11.

On the protrusion 4 of each SOA A1, A2, etc, there is formed a respective contact 7 extending along the optical axes of the SOAs A1, A2, etc. The contact 7 does not extend along the full length of the SOAs A1, A2 etc, but only along the length of the active region which is electrically pumped. A common contact 8 is formed on the opposite surface 1b of the semiconductor chip 1. The common contact 8 extends across each of the SOAs A1,A2, etc. In use, a drive current is passed between the contact 7 of a respective SOA A1, A2, etc and the common contact 8 to pump the active region of the respective SOA A1, A2, etc and cause it to amplify the light passing along the waveguide 2. The respective contacts 7 extend across only the central portion of each protrusion 4. Accordingly, the edges of the horizontal surface of the protrusions 4 beyond the respective contacts 7, extending along the length of the SOAs A1, A2, etc between the end facets 9, form vertical-alignment surfaces 6 which are used for alignment, as will be described in more detail below.

The passive device 11 is illustrated in FIGS. 3 and 4, in plan view and cross-sectional view, respectively. The structure of the passive device 11 will now be described.

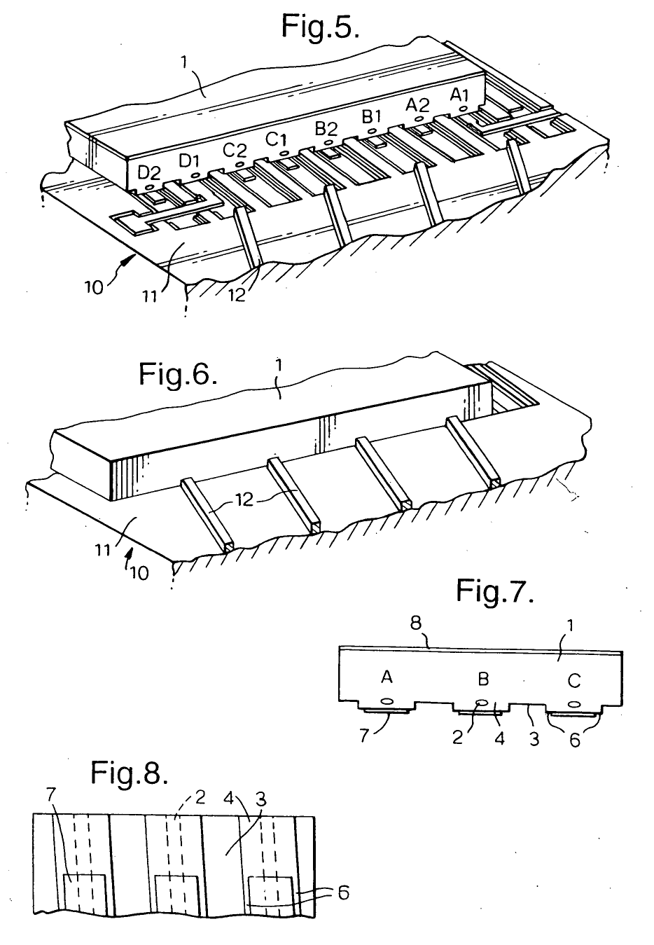

The passive device 11 is manufactured from any suitable passive materials, such as silica-on-silicon, silicon or polymers, using conventional techniques. An array of waveguides 12 with parallel optical axes are arranged on the substrate 10, in particular integrated with the substrate 10. As shown in FIGS. 3 and 4, a cladding layer 20 is provided over the waveguides 12. Such a cladding layer 20 is appropriate, for example, if the waveguides 12 are made of silica, but may be omitted if the waveguides are made of, for example, silicon. The cladding layer 20 is not shown in FIGS. 5 to 6 to prevent it from obscuring details of those Figures.

As will be described in more detail below, when the semiconductor chip 1 is mounted on the substrate 10, the SOAs A1, A2, etc are optically coupled to the waveguides 12 so that the array of SOAs A1, A2, etc and the passive device 11 together form an optical assembly. By appropriate design of the SOAs A1, A2, etc and the waveguides 12, optical assemblies with a wide range of functionality may be provided.

The waveguides 12 terminate at one end 13, beyond which the substrate 10 is provided with the following structure for receiving the SOAs A1, A2, etc. In particular, the substrate 10 has a plurality of grooves 14, each having an identical shape. The grooves 14 extend at a slight angle to the optical axes of the waveguides 12. The angle of the grooves 14 with respect to the waveguides 12 are chosen having regard to the angle of the waveguides 2 of the SOAs A1, A2 etc with respect to the end facets 9 and the refractive indices of the materials of the waveguides 12 and the SOAs A1, A2, etc, so that light directed along the optical axis of one of the waveguides 2 or 12 is refracted along the optical axis of the other one of the waveguides 2 or 12.

The grooves 14 are repeated at the same pitch as the array of SOAs A1, A2, etc in the semiconductor chip 1. The grooves 14 have a constant cross-section along their length. During manufacture, the grooves 14 may be formed by etching which allows accurate control of their dimensions.

The grooves 14 are stepped to have a pair of ledges 15 on opposite sides of the groove 14 across the width, with a central well 16 extending deeper than the ledges 15. The horizontal, upper surfaces 17 of the ledges 15 constitute vertical-alignment surfaces 17 which correspond to the vertical-alignment surfaces 6 of the protrusions 4 of each SOA A1, A2, etc in the semiconductor chip 1. The vertical surfaces 18 of the grooves 14 on one side of the central well 16 constitute horizontal-alignment surfaces 18 which correspond to the horizontal-alignment surfaces 5 of the protrusions 4 of each SOA A1, A2, etc. The contact between the vertical-alignment surfaces 6 and 17 and between the horizontal-alignment surfaces 5 aligns the SOAs A1, A2, etc with the substrate 10 and hence the waveguides 12, as follows.

The horizontal-alignment surfaces 18 of the grooves 14 on the substrate 10 are spaced apart by the same distance as the horizontal-alignments surface 5 formed on the protrusion 4 of each SOA A1, A2. Hence, contact between the horizontal alignment surfaces 5 and 18 align the array of SOAs A1, A2, etc on the semiconductor chip 1 with the array of waveguides 12 on the substrate 10 in the horizontal direction in which the array of SOAs A1, A2, etc repeats and in which the array of waveguides 12 repeats, as a result of the horizontal-alignment surfaces 5 and 18 extending vertically. The etching to form the grooves 3 in the semiconductor chip 1 and the grooves 14 in the substrate 10 may be accurately controlled. Thus it is possible to precisely align the SOAs A1, A2, etc and the waveguides 12 in the horizontal direction.

Contact between the vertical-alignment surfaces 6 on each protrusion 4 of the semiconductor chip 1 and the vertical-alignment surfaces 17 of each groove 14 on the substrate 10 aligns the array of SOAs A1, A2, etc with the array of waveguides 12 in the vertical direction perpendicular to that in which the array of SOAs A1, A2, etc repeats, as a result of the vertical-alignment surfaces 6 and 17 extending in the horizontal direction and parallel to the optical axes of the SOAs A1, A2, etc and the waveguides 12. During manufacture of the semiconductor chip 1, typically by a deposition process such as MOCVD (metalorganic chemical vapour deposition), it is possible to precisely control the vertical distance between the waveguides 2 of the SOAs A1, A2, etc and the vertical-alignment surface 6, because the thickness of the layer deposited above the waveguides 2 of each SOA A1, A2, etc may be controlled. Similarly, during the manufacture of the grooves 14 in the substrate 10 by etching, it is possible to precisely control the depth of the vertical-alignment surfaces 17 below the waveguides 12 formed on the substrate 11. As a result, the SOAs A1, A2, etc in the semiconductor chip 1 and the waveguides 12 on the substrate 10 may be precisely aligned in the vertical direction.

The central well 16 of each groove 14 is wider than the respective contact 7 formed on each protrusion 4 on the semiconductor chip 1. As a result, the respective contact 7 fits entirely within the central well 16 without preventing contact between the vertical-alignment surfaces 6 and 17.

Within the well 16, there is provided solder 19 for making an electrical contact with the respective contact 7 when the semiconductor chip 1 is mounted on the substrate 10. An electrical track 20 extends from the solder 19 to form a terminal for making an electrical connection.

Assembly of the optical assembly of the semiconductor chip one and the passive device 11 will now be described with reference to FIGS. 5 and 6.

Subsequent to testing of the individual SOAs A1, A2 etc, the semiconductor chip 1 is positioned above the substrate 10 with the SOAs A1, A2, etc arranged roughly over a respective groove 14, as shown in FIG. 5. The semiconductor 1 is then lowered onto the substrate 10, inserting the protrusions 4 on the semiconductor chip 1 into the respective grooves 14 in the substrate 10. The semiconductor chip 1 and the passive device 11 are heated sufficiently to melt the solder 19 in the wells 16 of the grooves 14 in the substrate 10. This allows the vertical-alignment surfaces 6 and 17 to come into contact which fixes the vertical alignment of the semiconductor chip 1 with the substrate 10. While the solder 19 is molten the semiconductor chip 1 is slid along the substrate 10, with the horizontal alignment surfaces 5 and 18 in contact, until the end facets 9 of the semiconductor chip 1 are adjacent (in contact with or at a known distance from) the ends 13 of the waveguides 12 so that the SOAs A1, A2, etc are optically coupled to the waveguides 12. Subsequently, the heating ceases and the solder 19 solidifies, which affixes the semiconductor chip 1 to the substrate 10.

The waveguides 12 are arranged at a predetermined pitch. The SOAs A1, A2, etc are arranged in the semiconductor chip 1 at a pitch equal to the predetermined pitch of the waveguides 12 divided by two. The grooves 14 are arranged in the substrate 10 at the same pitch as the SOAs A1, A2, etc the predetermined pitch of the waveguides 12 divided by two. The waveguides 12 are arranged to align with the waveguides 2 of SOAs A1, A2 etc within respective grooves 14. However, as the grooves 14 are arranged at a shorter pitch, alternate grooves 14 are not adjacent a waveguide 12.

As a result of the differing pitches at which the SOAs A1, A2, etc and the waveguides 12 are arranged, the array of SOAs A1, A2, etc is redundant in the sense that it effectively comprises two interleaved sub-arrays of SOAs, labelled A1, B1, C1, D1 and A2, B2, C2, D2 respectively, each sub-array being arranged at the predetermined pitch of the waveguides 12. Therefore, either one of the sub-arrays of SOAs A1, B1, C1, D1 or A2, B2, C2, D2 may be optically coupled to the array of waveguides 12. This means that there is a greater chance of one or other of the sub-arrays of SOAs A1, B1, C1, D1 or A2, B2, C2, D2 being entirely functional, than for a single array of SOAs arranged in a semiconductor chip at the predetermined pitch of the waveguides 12. This is because the probability of a single SOA failing is substantially independent of the number of SOAs 4 on the semiconductor chip 1. Thus the manufacturing yield for the array of SOAs A1, A2, etc on the semiconductor chip 1 as a whole is increased due to the redundancy.

Prior to mounting the semiconductor chip 1 on the substrate 10, the individual SOAs A1, A2, etc are tested to identify one or other of the sub-arrays A1, B1, C1, D1 or A1, B2, C2, D2 of SOAs which all function. When the semiconductor chip 1 is mounted on the substrate 10, the identified sub-array of SOAs A1, B1, C1, D1 or A2, B2, C2, D2 is arranged in the grooves 14, adjacent the waveguides 12, to be optically coupled to the waveguides 12. There is an additional groove 14 provided beyond the waveguides 12 at each end of the array. In general for an array of n waveguides, where the reduced pitch is the predetermined pitch of the waveguides 12 divided by an integer m there will be (m−1) waveguides 12 arranged beyond each ends of the array of waveguides 12, so that the total number of grooves 14 is ((nm)+m−1). This is to allow positioning of the semiconductor chip one with either one of the sub-arrays of SOA A1, B1, C1, D1, or A2, B2, C2, D2 aligned with the array of waveguides 12.

In the embodiment illustrated in FIGS. 1 to 6, there are four waveguides in the array, but this is merely for illustration and in fact the number of waveguides may be any plural integer. Similarly, in the described embodiment, the reduced pitch of the SOAs A1, A2, etc and the grooves 14 is equal to the predetermined pitch of the waveguides 12 divided by two, but this is merely for illustration and in general, the reduced pitch may be the predetermined pitch of the waveguides 12 divided by any plural integer. Indeed, as the integer increases, the redundancy factor and hence the manufacturing yield for the semiconductor chip 1 as a whole increases. However, in practice, there will be a maximum limit dependant of the practical limits on the minimum size and separation of the SOAs A1, A2, etc in the array.

In this embodiment, the spacing between the SOAs A1, A2, etc is constant because the SOAs A1, A2, etc are arranged at a constant pitch equal to the predetermined pitch of the waveguides divided by the integer. However, this is not essential. As an alternative, the interleaved sub-arrays may be offset from the position where the spacing between all adjacent SOAs A1, A2, etc is the same, so the spacing between successive SOAs A1, A2, etc is not constant. A constant pitch is preferred because it maximises the smallest separation between adjacent SOAs A1, A2 etc.

In general, the increase in yield may be quantified as follows. For an array of n waveguides 12, if the yield for an individual SOA is p (that is the probability that an individual SOA will function), then the yield for a semiconductor chip having an array of SOAs at the same pitch as the waveguides 12, as in the prior art, is p^{n.}. For a semiconductor chip 1 in accordance with the present invention where the SOAs A1, A2, etc are arranged at a reduced pitch equal to the predetermined pitch of the waveguide 12 divided by an integer m, then the yield for the array as a whole is equal to 1−(1−pⁿ)^{m}. As p is less than one, the yield is inevitably increased.

The following table illustrates the yield for some typical values of n and p and for values of m of two and four. In the table, the yields are shown as percentages.

| Waveguide | | Array Yield | Array Yield | Array Yield |
|---|---|---|---|---|
| Count | Device Yield | Prior Art | Half Pitch | Quarter Pitch |
| n | p | pⁿ | 1-(1-pⁿ)² | 1-(1-pⁿ)⁴ |
| 4 | 90% | 66% | 88% | 99% |
| 4 | 75% | 32% | 53% | 78% |
| 4 | 60% | 13% | 24% | 43% |
| 8 | 90% | 43% | 68% | 89% |
| 8 | 75% | 10% | 19% | 34% |
| 8 | 60% | 1.7% | 3.3% | 6.6% |
| 16 | 90% | 19% | 34% | 56% |
| 16 | 75% | 1.0% | 2.0% | 3.9% |
| 16 | 60% | 0.028% | 0.056% | 0.113% |

As can be seen from the table, the increases in yield as compared to the prior art are significant.

Numerous variations of the embodiment described above are as envisaged, for example as follows.

In the embodiments described above, the grooves 14 which define the alignment surfaces 17 and 18 are repeated at the same pitch as the SOAs A1, A2, etc. This is advantageous in that alignment is improved because all the SOAs A1, A2, including those which are not optically coupled to a waveguide 12 are contacted by the respective alignment surfaces 17 and. 18 of the substrate 10. This also improves thermal transfer, because each of the SOAs A1, A2, etc contact solder 19 in a respective well 16, the solder 19 acting as a heat sink. However, it is not essential to repeat the alignment features at the reduced pitch. As an alternative, the grooves 14 may be repeated at the predetermined pitch of the array of waveguides 12 so that the alignment surfaces 17 and 18 of the substrate 10 only contact the alignment surfaces 5 and 6 of one of the sub-arrays of SOAs A1, B1, C1, D1 or A2, B2, C2, D2.

The form and arrangement of the alignment surfaces 17 and 18 may be varied in other ways too. For example, these surfaces may be replaced by differently angled alignment surfaces extending parallel to the optical axis of the waveguides 12. One or all of the vertical-alignment surfaces and horizontal-alignment surfaces may be omitted, in which case alignment may be achieved actively, in a conventional manner. Alternatively, the alignment surfaces may be replaced by different alignment features, for example stops formed on the substrate 10. Another alternative is to provide alignment features for the semiconductor chip 1 and the substrate 10 as a whole, rather than for the individual SOAs A1, A2, etc.

An alternative which has particular benefit is to add a number of SOAs in the semiconductor chip 1 which is greater than the number of waveguides 12 multiplied by the integer m which is the ratio of the pitch of the SOAs A1, A2, etc to the predetermined pitch of the waveguides 12. For example, this may be achieved in the embodiment of FIGS. 1 to 6 by omitting one of the waveguides 12, so that the array of waveguides 12 has only three waveguides 12. This has the effect of further increasing the redundancy in the array of SOAs A1, A2, etc, because there is an increased number of sub-arrays of SOAs which may be coupled to the waveguides 12. In the example in the just mentioned case where one waveguide is omitted, the following sub-array of SOAs may be used: A1,B1,C1; B1,C1,D1; A2, B2, C2; or B2, C2, D2. The increased redundancy further increases the manufacturing yield of the semiconductor chip 1 as a whole, because it further increases the probability of there being a sub-array of SOAs which all function.

An optical assembly in accordance with the second aspect of the present invention will be described with reference to FIGS. 7 to 11.

Except as will be described below, the optical assembly in accordance with the second aspect of the present invention is the same as the optical assembly in accordance with the first aspect of the present invention described with reference to FIGS. 1 to 6. Therefore, for brevity, in respect of the common elements, the same reference numerals will be used and a description thereof will not be repeated.

In particular, the optical assembly in accordance with the second aspect of the invention has the following differences from the optical assembly in accordance with the first aspect. The semiconductor chip 1 has an array SOAs labelled A, B, C arranged at a pitch equal to the predetermined pitch at which the waveguides 12 are arranged on the substrate 10 of the passive device 11. The grooves 14 defining the alignment surfaces 17 and 18 are also arranged at the predetermined pitch at which the waveguides 12 are arranged on the substrate 10. Furthermore, the number of SOAs A, B, C on the semiconductor chip 1 is greater than the number of waveguides in the array of waveguides 12 on the substrate 10. In particular, the semiconductor chip 1 has three SOAs A, B, C and the passive device 11 has an array of 2 waveguides 12 arranged on the substrate 10, but this is merely for illustration and, in general, the passive device 11 may have any number of waveguides 12 and the semiconductor chip 1 may have any, greater number of SOAs.

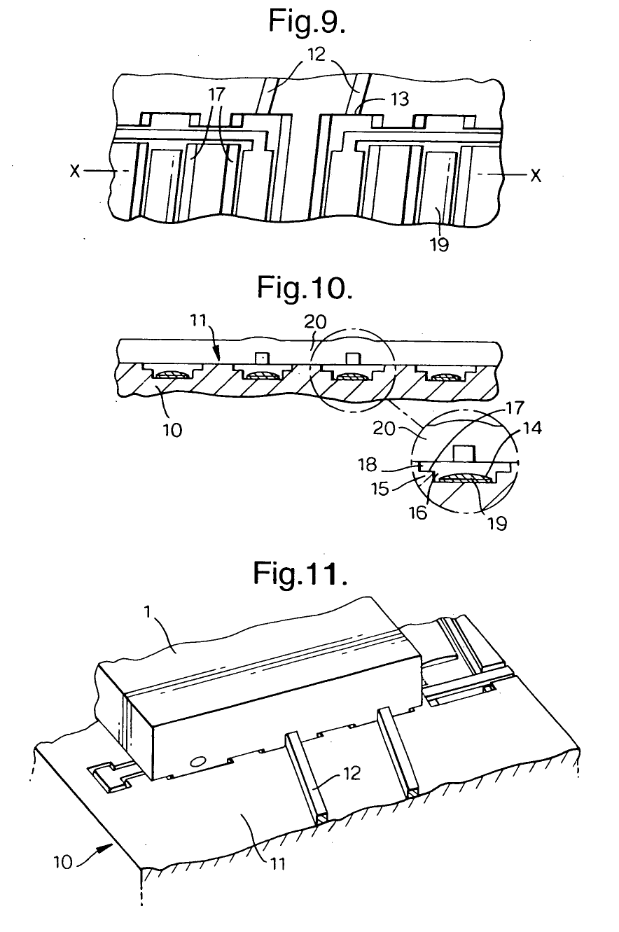

Also, as well as providing grooves 14 adjacent the end 13 of each waveguide 12, a number of grooves 14 equal to the difference between (a) the number of SOAs A, B, C of the semiconductor chip 1 and (b) the number of waveguides 12 arranged on the substrate 10, are provided beyond each end of the array of waveguides 12. Therefore, in the embodiment illustrated in FIGS. 9 and 10, a single groove 14 is provided beyond each end of the array of waveguides 12.

The semiconductor chip 1 and the passive device 10 are individually manufactured using conventional techniques to have a number of SOAs A, B, C and waveguides 12, respectively, as discussed above. The semiconductor chip 1 is preferably manufactured by initially manufacturing a semiconductor wafer in which is integrated a large number of SOAs greater than the number of SOAs intended to constitute a single semiconductor chip 1. Subsequently, individual semiconductor chips 1 are cleaved from the semiconductor wafer.

The presence of a larger number of SOAs A to C in the semiconductor chip 1 than the number of waveguides 12 of the passive device 11 provides a redundant number of SOAs A, B, C in the semiconductor chip 1. This provides the advantage that the manufacturing yield for the array of semiconductor devices 1 is increased. After manufacture of the semiconductor chip 1, the individual SOAs A, B, C are tested to identify a group of adjacent SOAs having the same number of SOAs as the array of waveguides 12, in this case two, which all function. Such testing is conventionally performed when manufacturing an array of semiconductor optical devices to determine whether all the devices function. However, in the present case, the redundancy in the semiconductor chip 1 means that there is more than one such group of adjacent SOAs which might all function, that is the SOAs A and B or the SOAs B and C. Therefore, there is an increased probability of there being such a group of functional SOAs, as compared to an array of SOAs having the same number of SOAs as the number of waveguides 12. This increases the manufacturing yield for the array of SOAs as a whole.

Subsequently, the identified group of adjacent SOAs A, B or B, C are optically coupled to the array of waveguides 12 by mounting the semiconductor chip 1 on the substrate 10 so that the array of SOAs A, B, C and the passive device 11 together form an optical assembly. The mounting is performed in the same manner as described above for the embodiment in accordance with the first aspect of the present invention. This is illustrated in FIG. 11 in the case that the identified group of functional SOAs is SOAs B and C.

Numerous variations of the embodiment described above are envisaged, just as for the embodiment in accordance with the first aspect of the invention.

We claim:

1. A method of manufacturing an array of semiconductor optical devices in a single semiconductor chip to be optically coupled to an array of waveguides arranged at a predetermined pitch, the method comprising manufacturing of the array of semiconductor optical devices as a plural number of interleaved sub-arrays of semiconductor optical devices arranged, in each sub-array, at a pitch equal to the predetermined pitch.

2. A method according to claim 1, comprising manufacturing the array of semiconductor optical devices with a pitch equal to the predetermined pitch divided by said plural number.

3. An optical assembly comprising an array of semiconductor optical devices formed in a single semiconductor chip and optically coupled to an array of waveguides arranged at a predetermined pitch, wherein the array of semiconductor optical devices comprises a plural number of interleaved sub-arrays of semiconductor optical devices arranged, in each sub-array, at a pitch equal to the predetermined pitch.

4. An optical assembly according to claim 3, wherein the semiconductor optical devices are arranged at a pitch equal to the predetermined pitch of the array of waveguides divided by said plural number.

5. An optical assembly according to claim 3, wherein the array of waveguides are integrated in a passive structure.

6. An optical assembly according to claim 3, wherein the array of waveguides are arranged on a substrate and the array of semiconductor optical devices is mounted on the substrate.

7. An optical assembly according to claim 6, wherein the array of waveguides are integrated with the substrate.

8. An optical assembly according to claim 6, wherein the substrate has alignment features for aligning a semiconductor optical device with respect to the substrate by contact with corresponding features of the semiconductor optical device, the alignment features being repeated at a pitch equal to the pitch of the array of semiconductor optical devices.

9. An optical assembly according to claim 8, wherein each of the repeated alignment features includes at least one alignment surface extending parallel or at a predetermined angle to the optical axes of the waveguides, and each of the semiconductor optical devices have at least one corresponding alignment surface contacting the at least one alignment surface of the repeated alignment features.

10. An optical assembly comprising according to claim 9, wherein the at least one alignment surface of the repeated alignment features includes a vertical-alignment surface extending in the horizontal direction in which the array repeats.

11. An optical assembly according to claim 10, wherein the at least one alignment surface of the repeated alignment features includes a horizontal-alignment surface extending in the vertical direction perpendicular to that in which the array repeats.

12. An optical assembly according to claim 3, wherein the number of semiconductor optical devices is greater than the number of waveguides multiplied by said plural number.

13. An optical assembly according to claim 3, wherein the semiconductor chip is formed substantially of materials in Groups III and V of the periodic table.

14. An optical assembly according to claim 3, wherein the base materials of the semiconductor chip are In and P.

15. An array of semiconductor optical devices formed in a single semiconductor chip, wherein the array of semiconductor optical devices comprises a plural number of interleaved sub-arrays of semiconductor optical devices arranged, in each sub-array, at a pitch equal to the predetermined pitch.

16. An array of semiconductor optical devices according to claim 15, wherein the array of semiconductor optical devices are arranged at a pitch equal to a predetermined pitch of an array of waveguides divided by said plural number.

17. An array of semiconductor optical devices according to claim 15, wherein the semiconductor chip is formed substantially of materials in Groups III and V of the periodic table.

18. An array of semiconductor optical devices according to claim 15, wherein the base materials of the semiconductor chip are In and P.

19. A substrate having an array of waveguides arranged thereon at a predetermined pitch and having alignment features for aligning a semiconductor optical device with respect to the substrate, wherein the alignment features are repeated in an array comprising a plural number of interleaved sub-arrays of alignment features arranged, in each sub-array, at a pitch equal to the predetermined pitch.

20. A substrate according to claim 19, wherein the alignment features are repeated at a pitch equal to the predetermined pitch divided by said plural number.

21. A substrate according to claim 19, wherein the array of waveguides are integrated in a passive structure.

22. A substrate according to claim 19, wherein the array of waveguides are integrated with the substrate.

23. A substrate according to claim 19, wherein each of the repeated alignment features includes at least one alignment surface extending parallel to the optical axes of the waveguides, and each of the semiconductor optical devices have at least one corresponding alignment surface contacting the at least one alignment surface of the repeated alignment features.

24. A substrate according to claim 23, wherein the at least one alignment surface of the repeated alignment features includes a vertical-alignment surface extending in the horizontal direction in which the array repeats.

25. An optical assembly comprising according to claim 24, wherein the at least one alignment surface of the repeated alignment features includes a horizontal-alignment surface extending in the vertical direction perpendicular to that in which the array repeats.

26. A method of manufacturing an array of semiconductor optical devices integrated in a single semiconductor chip to be optically coupled to an array of n waveguides arranged at a predetermined pitch, where n is an integer greater than one,
the method comprising:
manufacturing the semiconductor chip to have, integrated therein, the array of semiconductor optical devices arranged at a pitch equal to the predetermined pitch, with the number of semiconductor optical devices in the array being greater than n; and
testing the semiconductor optical devices of the array to identify a group of n adjacent semiconductor optical devices which all function.

27. A method of manufacturing an array of semiconductor optical devices according to claim 26, further comprising optically coupling the identified group of n adjacent semiconductor optical devices to the array of n waveguides.

28. A method of manufacturing an array of semiconductor optical devices according to claim 26, wherein said step of manufacturing a semiconductor chip comprises:
manufacturing a semiconductor wafer in which is integrated a number of semiconductor optical devices greater than the number of semiconductor devices of said array; and
cleaving semiconductor chip from the semiconductor wafer.

29. An optical assembly comprising an array of semiconductor optical devices integrated in a single semiconductor chip and optically coupled to an array of waveguides arranged at a predetermined pitch, wherein the array of semiconductor optical devices are arranged at a pitch equal to the predetermined pitch of the array of waveguides and the number of semiconductor optical devices is greater than the number of waveguides in the array of waveguides.

30. An optical assembly according to claim 29, wherein the array of waveguides are integrated in a passive structure.

31. An optical assembly according to claim 29, wherein the array of waveguides are arranged on a substrate and the semiconductor chip is mounted on the substrate

32. An optical assembly according to claim 31, wherein the array of waveguides are integrated with the substrate

33. An optical assembly according to claim 29, wherein the substrate has alignment features for aligning a semiconductor optical device with respect to the substrate

34. An array of semiconductor optical devices integrated in a single semiconductor chip, wherein the array of semiconductor optical devices are arranged at a pitch equal to a predetermined pitch of an array of waveguides and the number of semiconductor optical devices is greater than the number of waveguides in the array of waveguides.
